(19) United States
(12) Patent Application Publication
(10) Pub. No.: US 2014/0148132 A1
(43) Pub. Date: May 29, 2014

(54) METHOD AND APPARATUS FOR PROVIDING COMMUNICATION SERVICES OVER AUDIO MESSAGES

(71) Applicants: Jan Michael Pelttari, Bangalore (IN); Kamini Sanjay, Bangalore (IN); Harsha Ramamurthy Joshi, Bangalore (IN)

(72) Inventors: Jan Michael Pelttari, Bangalore (IN); Kamini Sanjay, Bangalore (IN); Harsha Ramamurthy Joshi, Bangalore (IN)

(73) Assignee: Nokia Corporation, Espoo (FI)

(21) Appl. No.: 13/807,155

(22) PCT Filed: Jun. 1, 2011
(86) PCT No.: PCT/FI11/50514

§ 371 Date: Dec. 12, 2013

(30) Foreign Application Priority Data
Jun. 29, 2010 (IN) 1839/CHE/2010

(51) Int. Cl. H04W 4/12

(52) U.S. Cl. CPC H04W 4/12
USPC 455/412.1

(57) ABSTRACT

An approach is presented for providing communication services over audio messages. A voice platform determines to act on a request to establish one or more calls among one or more devices and one or more services, the one or more calls including, at least in part, an audio message associated with the one or more services. Further, the voice platform causes, at least in part, actions that result in establishment of the one or more calls for transmission and storage of the audio message at the one or more devices, the one or more services, or a combination thereof.

### BACKGROUND

Service providers and device manufacturers (e.g., wireless, cellular, etc.) are continually challenged to deliver value and convenience to consumers by, for example, providing compelling network services. As a result, users are becoming increasingly accustomed to having access to a variety of communication services (e.g., social networking, chatting, messaging, on-demand information, etc.). However, these services typically use more advance communication resources (e.g., data networks). Accordingly, service providers and device manufacturers face significant technical challenges to enabling equivalent services using specifically voice or audio based communications resources, particularly where data networks are expensive or otherwise limited.

### SOME EXAMPLE EMBODIMENTS

Therefore, there is a need for an approach for efficiently providing services using voice and/or audio based communications.

According to one embodiment, a method comprises determining to act on a request to establish one or more calls among one or more devices and one or more services, the one or more calls including, at least in part, an audio message associated with the one or more services. The method also comprises causing, at least in part, actions that result in establishment of the one or more calls for transmission and storage of the audio message at the one or more devices, the one or more services, or a combination thereof.

According to another embodiment, an apparatus comprising at least one processor, and at least one memory including computer program code, the at least one memory and the computer program code configured to, with the at least one processor, cause, at least in part, the apparatus to determine to act on a request to establish one or more calls among one or more devices and one or more services, the one or more calls including, at least in part, an audio message associated with the one or more services. The apparatus is also caused to cause, at least in part, actions that result in establishment of the one or more calls for transmission and storage of the audio message at the one or more devices, the one or more services, or a combination thereof.

According to another embodiment, a computer-readable storage medium carrying one or more sequences of one or more instructions which, when executed by one or more processors, cause, at least in part, an apparatus to determine to act on a request to establish one or more calls among one or more devices and one or more services, the one or more calls including, at least in part, an audio message associated with the one or more services. The apparatus is also caused to cause, at least in part, actions that result in establishment of the one or more calls for transmission and storage of the audio message at the one or more devices, the one or more services, or a combination thereof.

According to another embodiment, an apparatus comprises means for determining to act on a request to establish one or more calls among one or more devices and one or more services, the one or more calls including, at least in part, an audio message associated with the one or more services. The apparatus also comprises means for causing, at least in part, actions that result in establishment of the one or more calls for transmission and storage of the audio message at the one or more devices, the one or more services, or a combination thereof.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing communication services over audio messages, according to one embodiment;

FIG. 2 is a diagram of the components of a voice platform, according to one embodiment;

FIG. 3 is a flowchart of a process for providing communication services over audio messages, according to one embodiment;

FIGS. 4A-4B are time sequence diagrams that illustrate sequences of messages and processes for providing communication services over audio messages, according to one embodiment;

FIGS. 5A-5F are diagrams of user interfaces utilized in the processes of FIG. 3, according to various embodiments.

FIGS. 6A-6C are diagrams of user interfaces utilized in the processes of FIG. 3, according to various embodiments.

FIGS. 7A-7C are diagrams of user interfaces utilized in the processes of FIG. 3, according to various embodiments.

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing communication services over audio or voice messages are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

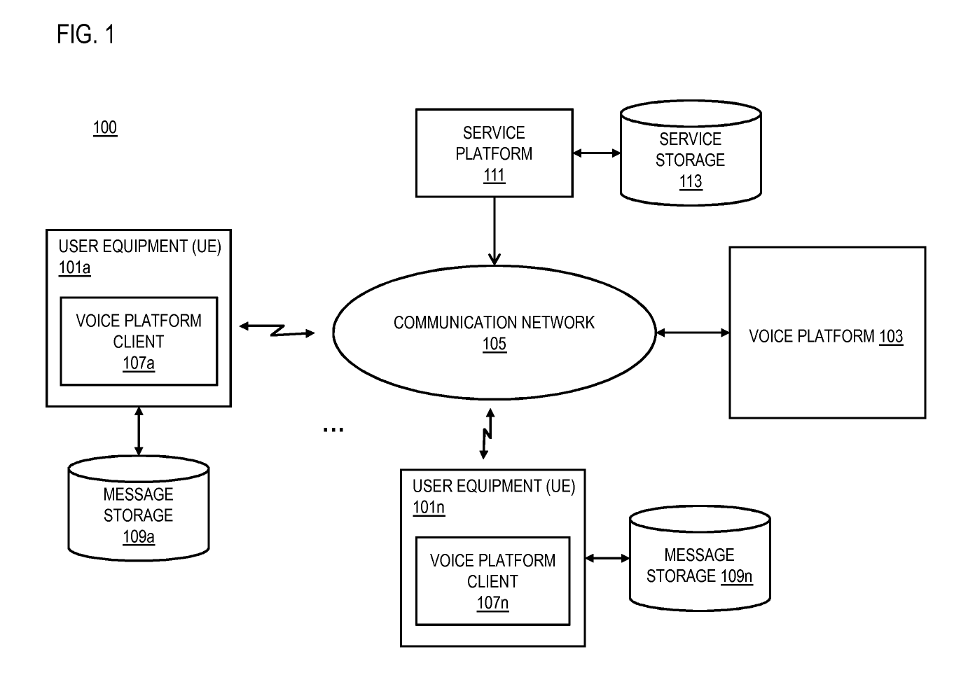

FIG. 1 is a diagram of a system capable of providing communication services over audio messages, according to one embodiment. As discussed previously, conventional communication services are generally provided over data networks even when those services use audio or voice based interactions. For example, popular services such as visual voicemail, multimedia messaging service (MMS), music downloads, and the like are heavily dependent on data resources. In the case of a visual voicemail service, for instance, when a user receives a voicemail message, a backend server typically digitizes the voicemail message as an audio file that is transmitted to a corresponding visual voicemail application on a user device for subsequent retrieval. More specifically, the transmission of the voicemail file occurs as data transmission over the data network of a communications service provider. The digital nature of the file then enables a user to increased functionality in interacting with the file such as having random access to different voicemail messages, improved playback controls etc. Similarly, MMS messages and music tracks are generally transmitted to the user's device over the data network as well. Accordingly, if the user has no data service or data service is not available, the user will not be able to access these types of services.

To address this problem, a system 100 of FIG. 1 introduces the capability to provide communication services as audio or voice messages from the service provider to a user device over voice-based communication resources (e.g., a voice call network). More specifically, the system 100 enables a voice platform 103 to determine to act on a request to establish a call among one or more UEs 101a-101n (also collectively known as UEs 101) and one or more services (e.g., information broadcasting service, messaging service, social networking service, music delivery service, etc.) of the service platform 111. In one embodiment, the UEs 101a-101n include respective voice platform clients 107a-107n to perform all or part of the functions of the voice platform 103. By way of example, the call can be established to exchange audio or voice based communications between the UEs 101 and the service platform 111 for transmitting service and/or control information. As shown, the service platform 111 has access to a service storage 113 for, among other things, storing audio or voice messages related to the services available from the service platform 111. Then, the voice platform 103 causes actions that result in establishment of the call to transmit and store the audio or voice based message at one or more of the UEs 101a-101n, the service platform 111, and/or another platform (not shown) with connectivity to the communication network 105. For example, audio messages transmitted to the UE 101 may be stored in the message storage 109 of the UE 101, and audio messages transmitted to one or more services of the service platform 111 can be stored in the service storage 113.

In one embodiment, the voice platform 103 may consider one or more criteria in selecting the one or more UEs 101 that are to receive the audio message (e.g., from the service platform 111) and place the call based on the selection criteria. In some embodiments, the criteria may be settings that the user may configure for the receiving UE 101. For example, a user can configure the UE 101 to receive all types of audio messages while blocking advertisement messages.

In another embodiment, the audio message may originate from a UE 101 for controlling or otherwise interacting with one or more services of the service platform 111. By way of example, in one sample use case, the voice platform 103 can mediate an audio message from the UE 101 to a social networking service of the service platform 111. The social networking service or the voice platform 103 can then recognize the speech in the audio message, parsed the recognized speech, and activate functions (e.g., posting functions) of the social networking service. Alternatively, the social networking service can be configured to receive and then post the audio message directly to the corresponding user's social networking home page or wall.

In certain embodiments, the transmission of the audio message to the UE 101 may be performed as a push or broadcast operation from the service platform 111 via the voice platform 103 to the UE 101 (e.g., broadcasting news reports, weather reports, emergency announcements, etc.).

Also, the voice platform 103 may also include a storage (not shown) to store audio messages, user preferences, and other related information.

In one embodiment, the voice platform 103 enables the establishment of calls as “silent calls” for exchanging audio messages between the UEs 101 and the service platform 111. As used herein, the term “silent calls” refer to calls established by the voice platform 103 between the UEs 101 and the service platform 111 so that users of the UE 101 are aware or undisturbed by the calls. More specifically, the voice platform 103 and/or the voice platform client 107 determine an idle state of the UE 101. By way of example, an idle state is when the UE 101 is not currently engaged in a voice call or when the voice communications resources of the UE 101 is not otherwise in use. In certain embodiments, the UE 101 may be placed in the idle state if the user of the UE 101 does not use the UE 101 for a predetermined period of time or by a user setting.

In one sample use case, a UE 101a has initiated a request to transmit an audio message to another UE 101n. Accordingly, the voice platform 103 first determines whether both the UE 101a and the UE 101n are in idle states. If the UEs 101a and 101n are in idle states, the voice platform 103 may establish a silent call from the UE 101a to the UE 101n to transmit an audio message. In another embodiment, the UEs 101a and 101n need not be in idle states at the same time. In this case, the voice platform 103 may determine when the UE 101a is in an idle state and initiate transfer of the message from the UE 101a to the voice platform 103. The voice platform 103 can next determine when the UE 101n is in an idle and then relay the message to the UE 101n accordingly.

Therefore, in one example, a user of the UE 101a may record an audio message at the UE 101a, and the audio message is transmitted as a silent call to the communication service 103 when the UE 101a is idle. The voice platform 103 may then determine whether the UE 101n is in the idle state. If the UE 101n is in the idle state, then the communication service 103 may make a silent call to the UE 101n and transmit the audio message to the UE 101n over the call such that the audio message may be stored at the UE 101n. The audio message may be stored at the UE 101n, or any other devices or services such that the user of the UE 101n may then later listen to the stored audio message at the UE 101n using, for instance, the voice platform client 107. Further, when the call is made to the UE 101n during the idle state, then the call may be made silently such that any indication of the call (e.g. ringing or vibration) is silenced.

In another sample use case, a traffic operator offer a service (e.g., via the service platform 111) that provides audio message with current traffic information. The traffic service is made available over the voice platform 103 so that no data network is needed. In this example, if the voice platform 103 determines that the UE 101 is in an idle state, the voice platform 103 initiates establishment of a silent call between the UE 101 to transmit the audio message with the traffic information to the UE 101 (e.g., the audio is played over the silent call and recorded at the UE 101), wherein the audio message of the traffic is stored and may be played or accessed later at the UE 101.

In another embodiment, the voice platform 103 may be used by the service platform 111 for broadcast communications. In this embodiment, a broadcast service of the service platform 111 may generate an audio message to include an alert message. The alert may relate to an emergency, a government message, news, weather conditions, environmental conditions, a public service, traffic conditions, or a combination thereof. For example, a government may issue an emergency message about a natural disaster (e.g., tsunami or earthquake) for broadcast via the voice platform 103. The voice platform 103 may then transmit the audio message with the alert to one or more recipient UEs 101 so as to inform and alert the recipients of the natural disaster.

In some embodiments, the voice platform 103 may consider criteria such as location, gender, age group, and the like to selectively send the audio message to the UEs 101. For example, the voice platform 103 may selectively send the audio message with an alert to communicate an upcoming possible tsunami to only the recipient devices located in the region affected by the possible tsunami and set the audio message to the language spoken in that region. Further, in one example, the audio message may be generated and distributed according to a characteristic of the user of the recipient UE 101. The characteristic of the user may be determined by a user input, wherein the user may use the user input to define characteristics such as age, gender, income, marital status, language, etc. The characteristic of the user may also be determined by the user's voice, wherein the user characteristic such as the user's age and gender may be approximated by analyzing the voice. Further, the recipient's UE 101 may include a location device such as a global positioning system (GPS) device or sensors such as a speed sensor, noise sensor, light sensor, etc. to acquire information that may be used to determine user characteristics, context information, etc. for application of the criteria or to set the criteria for receiving or transmitting audio messages via the system 100. Further, it is contemplated that receiving or transmitting the audio messages may also be affected by the user's usage patterns such as the user's search patterns (e.g., the type of music that the user frequently searches), times when the user makes the most phone calls, etc.

In another embodiment, the media services (e.g., music services) of the service platform 111 can use the voice platform 103 for delivering music or music samples as audio messages to the UEs 101. For example, the music service can generate the audio message to include a sample of the digital media according to the user preferences and deliver the sample via a silent call over the voice platform 103. This audio message may be sent to the recipient UE 101 for storage and subsequent playback using, for instance, the voice platform client 107. In another example, the voice platform 103 may act on a download request for the digital media, and then transmit the digital media to the recipient UE 101 from the music service. For example, the communication service 103 may send the audio message including a sample of a song to the recipient (i.e. a user of the UE 101), wherein the music service of the service platform 111 selects the song based on the user preferences. Then, the user of the UE 101 may listen to the audio message to listen to the sample of the song. The user of the UE 101 may send a download request for the song to the music service. The music service may response with another audio message via the voice platform 103 requesting payment from the user of the UE 101. Upon the receipt of the payment, the music service transmits the song as yet another audio message to the UE 101 via the voice platform 103.

Therefore, an advantage of this approach herein is that this approach provides an innovative way for the music service to deliver audio content via the voice platform 103. More specifically, audio can be delivered as direct audio over voice channels rather than digital files over data channels when a recipient UE 101 does want to use or otherwise does not have access to a data network.

In another embodiment, the voice platform 103 may transmit the audio message in a push operation to push content from the service platform 111 to the UE 101, and thus avoids the constant pull operation from a recipient to receive the audio message. Further, the transmission of the audio message may be based on various criteria, user characteristics and/or preferences, providing various implementations of the method to transfer the audio message. Therefore, means for transmitting an audio message to a recipient is anticipated.

As shown in FIG. 1, the system 100 comprises UEs 101 having connectivity to the voice platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UEs 101, the voice platform 103, and the service platform 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the voice platform client 107 and the voice platform 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

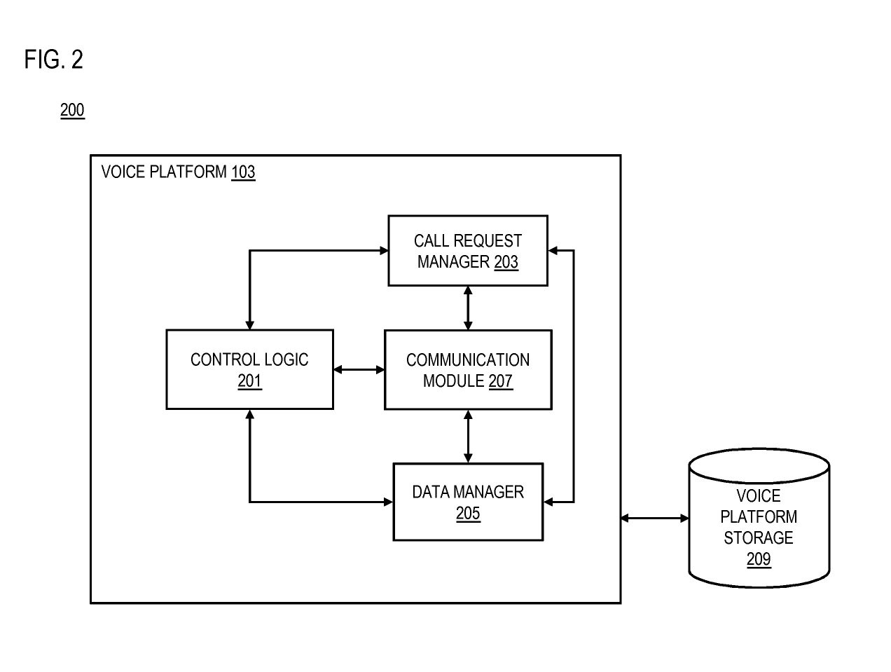

FIG. 2 is a diagram of the components of a voice platform, according to one embodiment. By way of example, the voice platform 103 includes one or more components for providing communication services over audio messages. It is contemplated that the functions of these components may be combined in one or more components or performed by other components of equivalent functionality. In this embodiment, the voice platform 103 includes a control logic 201 for executing one or more functions of the voice platform 103, a call request manger 203 for managing requests to establish a call for exchanging audio messages among devices and services, a data manager 205 for acquiring and managing audio messages and related data, and a communication module 207 for coordinating communications between the voice platform 103 and other components of the communication network 105.

In one embodiment, the controller 201 interacts with the call request manager 203 to determine to act on a request to establish a call between one or more UEs 101 and one or more services of the service platform 111, wherein the call includes an audio message associated with the UEs 101 and/or one or more services of the service platform 111. In one embodiment, the call request manager 203 may consider criteria for selecting the participating parties when establishing the requested call. For example, a call to the recipient UE 101 may be established selectively based on the criteria applied to the UE 101 or a corresponding user. The criteria may include location preference, language, gender, age group, etc. In one example, if the call is specific for a certain location and a certain age group, the call request manager 203 would consider the criteria in order to make the call only to the recipients that satisfy the criteria for the location and the age group.

In one embodiment, the call request manager 203 may also interact with the service platform 111 to coordinate the generation the audio message (e.g., alert message, broadcast message, music delivery message, etc.) that is to be transmitted among the services and the UEs 101. The audio message may be generated and distributed according to the characteristic of the user of the UE 101, for example. The characteristic of the user may be determined by a user input of the user characteristic information such as the user's age, gender, marital status, etc. The characteristic of the user may also be determined by the user's use pattern and use history at the UE 101. Further, the characteristic of the user may be determined by device components at the UE 101 such as a location sensor (e.g. GPS), a sound sensor, a light sensor, a speed sensor, etc. Thus, some aspects of the characteristic of the user may overlap with some aspects of the criteria considered in the establishment of the call. In addition, among other options, the audio message may relate to an emergency, a government message, news, weather condition, environmental condition, a public service, traffic conditions, or a combination thereof. The call request manager 203 may consider the criteria to selectively transmit the audio message with the alert such that only the recipients that satisfy the criteria for the alert may receive the audio message with the alert.

The communication module 207 handles various aspects of communication between the voice platform 103 and other devices or services, as well as the communication within the voice platform 103. Thus, the communication module 207 manages actions that result in establishment of the call for transmission and storage at the recipient device, wherein the recipient device may be one or more UEs 101 or one or more services of the service platform 111. As noted previously, the transmission of the audio message performed by the communication module 207 may be performed as a push operation to the recipient. In one embodiment, the communication module 207 determines an idle state of a device in communication, and establishes the call based on the idle state. In one example, the communication module 207 may not establish the call to the recipient until the recipient is in the idle state. When the recipient is in the idle state, the communication module 207 may establish the call to the recipient to transmit the audio message and store the audio message at the recipient. This call during the idle state may be established as a silent call, wherein incoming call indication (e.g. ringing or vibration) at the recipient is silenced or otherwise made not apparent to a user of the recipient device. The communication module 207 also handles receiving of an audio message and related data. For example, the communication module 207 may receive an audio message from the UE 101a, wherein the audio message is directed to the UE 101n. Then, the communication module 207 may establish the call to transmit the audio message from the UE 101a to the UE 101n. In this example, the audio message from the UE 101a may be recorded and stored at the UE 101a first, and then may be transmitted to the communication service 103 when the UE 101a enters an idle state.

The data manager 205 manages data including the audio message, digital media, the user characteristic, the criteria and any other types of data, wherein some or all of the data may be stored in a voice platform storage 209. In one example, the data manager 205 may first store a received audio message in the voice platform storage 209, before the audio message is transmitted to a recipient UE 101. Further, the data manager 205 may also manage transmission of data, by working with the call request manager 203 and the communication module 207. For example, the call request manager 203 may determine user preferences for digital media (e.g. digital music), and the data manger 205 may communicate with the call request manager 203 and/or the corresponding music service to generate the audio message to include a sample of the digital media. This audio message is sent to the device corresponding to the user based predetermined user preferences. Further, the communication module 207 may receive a download request directed to the music service from the recipient device for the digital media. Then, the data manager 205 may determine whether to allow the download request. This determination may be based on the payment by the recipient device for the download of the digital media.

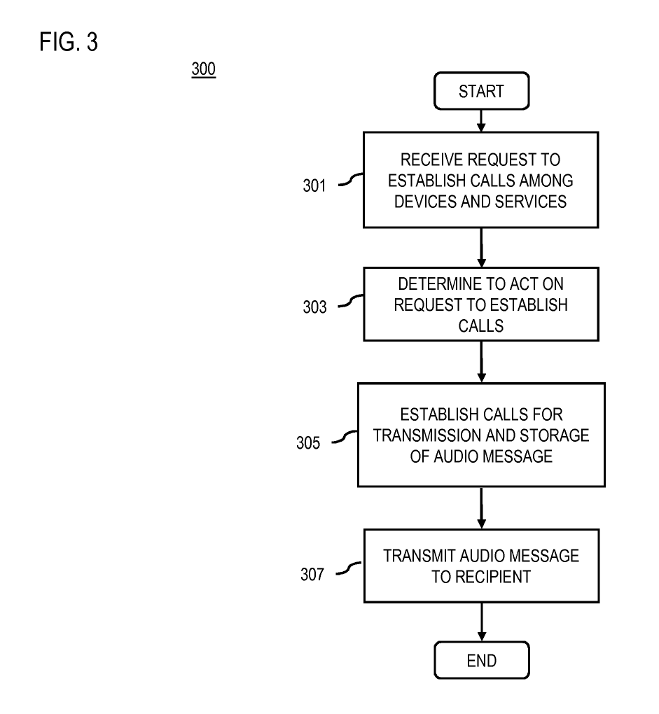

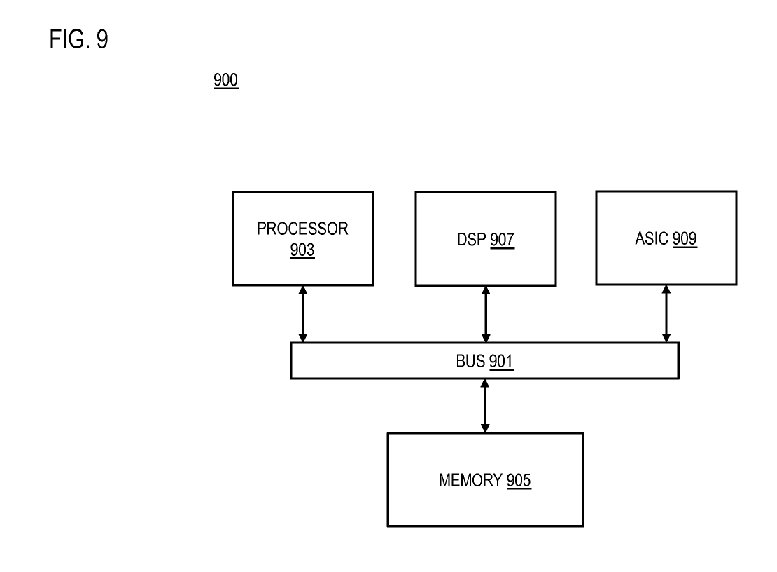

FIG. 3 is a flowchart of a process for providing communication services over audio messages, according to one embodiment. In one embodiment, the voice platform 103 performs the process 300 and is implemented in, for instance, a chip set including a processor and a memory as shown in FIG. 9. In addition or alternatively, the voice platform client 107 may perform all or a portion of the steps of the process 300. In step 301, the voice platform 103 receives a request to establish calls among devices and/or services. The request may come from one or more of the UEs 101 or the services of the service platform 111. By way of example, if the request comes from the UE 101a, then the UE 101a may send an audio message to the communication service 103, which may then be transmitted to another device (e.g. UE 101n) or the service platform 111. In another example, the request may come from a service of the service platform 111, such as a traffic service or a government institution alerting emergency, such that the audio message from the service may be relayed to be transmitted to the UE 101. In step 303, the voice platform 103 identifies a recipient to transmit the audio message. In one embodiment, the communication service 103 may be set such that if certain conditions are satisfied, the request to establish calls is made within the voice platform 103. In this example, the UE 101 may provide a setting such that an audio message that includes a sample of the top song of the week is transmitted to the UE 101 whenever a top song of the week is available. Then, when the communication service 103 determines that the top song of the week is available (e.g., via a music service of the service platform 111), the voice platform 103 makes a request to establish a call between the music service and the UE 101 to send the audio message including the sample music of the top song of the week.

In step 303, the voice platform 103 determines to act on the request to establish calls among the devices and/or the services. In determining to act on the request, the voice platform 103 may consider a state of the recipient of the audio message. For example, the voice platform 103 may enable transmitting the audio message to the recipient only when the recipient is in an idle state. The idle state may mean that the recipient device (e.g. UE 101) is not in use (e.g., the voice channel of the UE 101 is not in use) or has not been used for a predetermined period of time. This feature is advantageous in that the service platform 111 avoids transmitting the audio message while the participating devices are in an active call state. In another example, the voice platform 103 may determine to act on the request based on the criteria for selecting devices, services or a combination thereof. Thus, the voice platform 103 may consider criteria in selecting the recipient of the audio message. The criteria may be manually set by a user of the recipient device and/or the service platform 111 or be automatically set. For example, if the criteria is set such that UE 101a is open to receiving a traffic information whereas the UE 101n is set not to receive the traffic information, based on this criteria, the service platform 111 may determine to act on the request to establish call to send the traffic information to the UE 101a, but not to the UE 101n.

In one embodiment, the audio message may originate from a device such as the UE 101a. In this embodiment, the audio message may be recorded in the UE 101a before being transmitted to the communication service 103, wherein the destination (i.e. recipient) of the audio message is determined at the UE 101a. Then, the voice platform 103 may receive the audio message from the UE 101a and then transmit the message to the recipient, according to the destination determined at the UE 101a. In one example, The UE 101a may be configured to transmit the audio message to the communication service 103 only when the UE 101a is in an idle state. Thus, in this example, the user of the UE 101a may record the audio message at the UE 101a, and this audio message may be transmitted to the communication service 103 when the status of the UE 101a turns into an idle state. In another embodiment, the audio message may originate from a service of the service platform 111, such as a traffic service providing traffic information. In this embodiment, the traffic service may transmit the audio message with traffic information to the voice platform 103, and then the voice platform 103 may transmit the audio message to a recipient such as the UE 101n, according to the determination in step 303.

In step 305, the voice platform 103 causes actions that result in establishment of calls for transmission and storage of the audio message. Then, as shown in step 307, the voice platform 103 causes transmission of the audio message to a recipient. The transmission of the audio message to a recipient may be performed as a push operation (e.g., played to the recipient device over a voice call and recorded at the recipient for later use). As discussed previously, the recipient may be a device or a service. Thus, in one example, the call may be made between the service platform 111 and the UE 101 via the voice platform 103. For example, the call may be made between the UE 101 and a social networking service. In this example, a user of the UE 101 may generate the audio message at the UE 101 and designate a user account of the social networking service as a destination. This audio message may be transmitted from the UE 101 to the social networking service via the voice platform 103 by establishing a call to transmit and store the audio message at the social networking service, thereby updating the status of the user of the UE 101 at the user account of the social networking service.

In another embodiment, a communication broadcast service may generate the audio message to include an alert associated with the broadcast service. In one example, the generated audio message may be transmitted to the voice platform 103 for transmission to one or more recipients. In another example, the voice platform 103 itself may be the communication broadcast service generating the audio message including the alert. The audio message including the alert may relate to an emergency, a government message, news, weather condition, environmental condition, a public service, traffic conditions or a combination thereof. For example, a government may issue a tsunami warning as an alert included in the audio message, and the tsunami warning may be transmitted to the recipient device (e.g. UE 101). Further, the audio message including the alert may be generated based on a characteristic of the user of a recipient device. The characteristic of the user may be entered manually by a user input, to define characteristics such as age, gender, income, marital status, language, etc. The characteristic of the user may also be determined automatically by analyzing the user voice, wherein the characteristic such as the user's age and gender may be derived from the user voice. Further, sensors such as a location sensor (e.g. GPS device), a speed sensor, noise sensor, light sensor, etc. may be used to determine the user characteristic. The user characteristic may also be determined by analyzing the use pattern of the user's device, such as the user's search pattern, preference settings in the user's device, the most frequently used program, times when the user makes the most phone calls, and etc. Some or all of the user characteristics may also be used as criteria, wherein the calls established by the voice platform 103 are made based on the criteria as discussed previously. In one example of the embodiment, the audio messages may not be transmitted to the recipient unless the recipient device is in an idle state, while other audio messages with urgent alerts may always be transmitted to the recipient even if the recipient device is not in an idle state.

This process is advantageous in that it provides a way to transmit the audio message with an alert such that the recipient may be readily aware of the audio message. Further, this process provides an advantage of generating and transmitting the audio message based on the user characteristic, and thus providing flexibility and a targeted approach based on the user characteristic. Thus, this process provides an efficient way to deliver an audio message with an alert to a recipient. The voice platform 103 is a means for achieving this advantage.

In another embodiment, the voice platform 103 in connection with a music service of the service platform 111 determines user preferences for digital media, and then generates and distributes an audio message to include a sample of the digital media according to the user preferences. Then, the recipient (e.g. UE 101) may receive the audio message and hear the sample of the digital media such as digital music. The recipient may decide to obtain a full version of the digital media, and send a download request for the digital media. The music service of the service platform 111 may then receive the download request, and transmit the digital media to the recipient according to the download request via the voice platform 103.

This process is advantageous in that it provides an innovative way to access media files without using a data network. Thus, this process provides an efficient way to access the media tracks while minimizing use of data resources and costs related to accessing the communication service for the UE 101. The voice platform 103 is a means for achieving this advantage.

Further, in one embodiment, the communication between the UEs 101 and the voice platform 103 may be performed in whole or in part using the dual-tone multi-frequency (DTMF) signaling. According to this embodiment, each command and response may be formatted in the following pattern,
#d¹ d² #d³ d⁴ d⁵ d⁶ . . . dⁿ*,
   wherein the first two characters d¹ d² signifies an attribute and/or a command, and the next characters d³ to dₙ optionally signifies the value. These attributes and/or commands can then be used by the voice platform 103 and/or the service platform 111 to control receiving and/or transmitting one or more of the audio messages described with respect to the system 100.

The voice message send command issued by the sender device (e.g. UE 101a) and sent to the communication service 103 according to this embodiment may be in a form of:
#00# d³d⁴d⁵d⁶ . . . dⁿ*,
   wherein 00 means a message send command, and d³ d⁴ d⁵ d⁶ . . . dⁿ is a destination number.

The voice message receive command issued by the voice platform 103 and sent to the recipient device (e.g. UE 101n) according to this embodiment may be in a form of:
#10# d³ d⁴ d⁵ d⁶ . . . d^{n*},
   wherein 10 means a message receive command, and d³ d⁴ d⁵ d⁶ . . . dⁿ is a sender's subscriber number.

Further, the voice platform 103, the sender and the receive issue an acknowledge command resulted in success or failure. The acknowledge command may be in a form of:
#d¹ d²#

The meaning of the DTMF characters for the acknowledge command is shown in the table below:

TABLE 1

| DTMF characters | Meaning |
|---|---|
| d¹ d² -> 01 | Command SUCCESS from Message Center |
| d¹ d² -> 11 | Command SUCCESS from Device |
| d¹ d² -> 02 | Command FAILURE from Message Center |
| d¹ d² -> 12 | Command FAILURE from Device |

In addition, the acknowledge command is also used to handshake the sender on unreliable DTMF tone. The handshake command will reply back to the sender with the same data received by the receiver. The handshake reply may be in a form of:
#d¹d²#d³d⁴d⁵d⁶ . . . d^{n*}

The meaning of the DTMF characters for the handshake reply is shown in the table below:

TABLE 2

| DTMF characters | Meaning |
|---|---|
| d¹ d² -> 03 | Handshaking reply from Message Center to Device |
| d¹ d² -> 13 | Handshaking reply from Device to Message Center |
| d³ d⁴ d⁵ d⁶ . . . dⁿ | Value as recorded from the previous message at receiver |

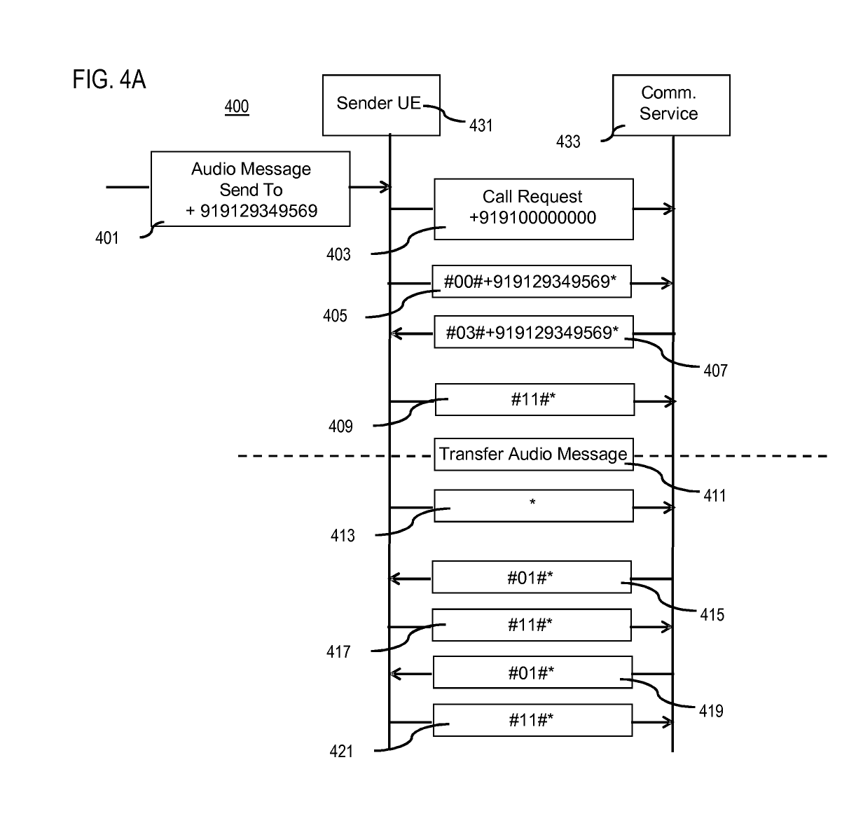

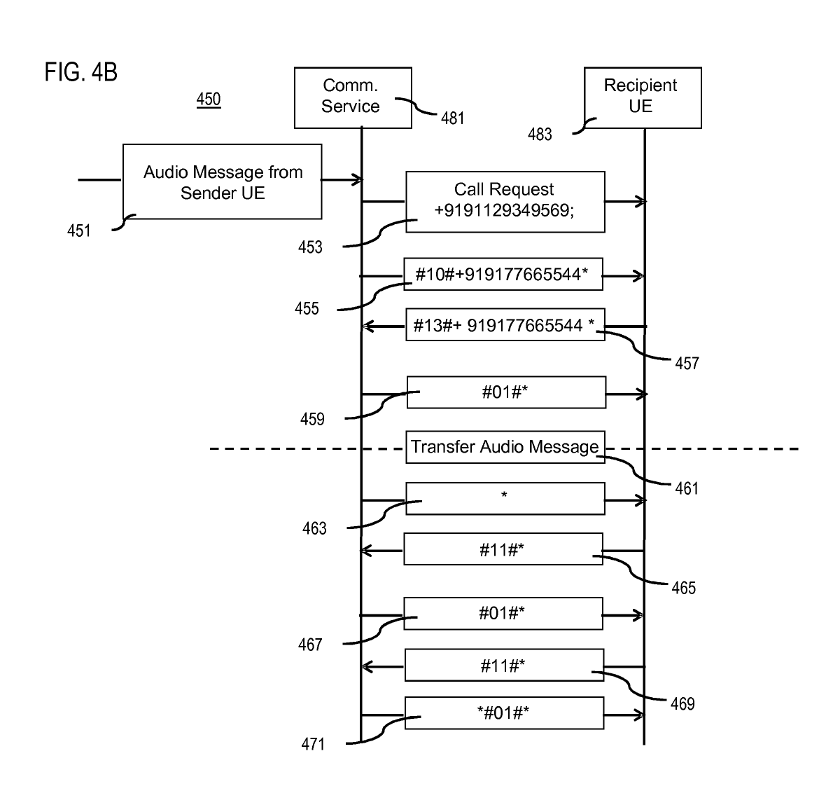

FIGS. 4A-4B are time sequence diagrams that illustrate sequences of messages and processes of use case scenario, according to one embodiment. FIG. 4A shows a send procedure with communication between the Sender UE 431 and the voice platform 433. First, in step 401, the request to send an audio message from the Sender UE 431 to the recipient having a phone number +919129349569 is made at the Sender UE 431. Then, the Sender UE 431 sends the call request to the voice platform 433 via the phone number +919100000000, as shown in step 403. Then, the voice message send command is sent from the sender UE 431 to the voice platform 433, with the destination number +919129349569 for the recipient device, as shown in step 405. In response, the voice platform 433 confirms the destination number and, as shown in step 407, sends a handshaking reply to the Sender UE 431. Upon success of this command, in step 409, the command SUCCESS is sent from the Sender UE 431 to the communication service 433. Then, the audio message is transferred from the sender UE 431 to the voice platform 433, as shown in step 411. The command signifying that the transfer of the audio message is completed (i.e. end of discussion of message) is then sent from the Sender UE 431 to the voice platform 433, as shown in step 413. Then, the voice platform 433 sends the command SUCCESS to the Sender UE 431, as shown in step 415, and in response, the Sender UE 431 sends the command SUCCESS to the voice platform 433, as shown in step 417. Again, the voice platform 433 sends the command SUCCESS to the Sender UE 431, as shown in step 419, and in response, the Sender UE 431 sends the command SUCCESS to the voice platform 433, as shown in step 421. Therefore, via steps 415-421, two acknowledgements are made that the voice platform 433 successfully received the audio message, and two acknowledgements are made that the Sender UE 431 successfully sent the audio message.

On the event of any failure or error, either the voice platform 433 or the Sender UE 431 can terminate at any point of time, as an abort procedure. However, this abort procedure needs to happen before the two acknowledgments via steps 415-421. Otherwise, result of procedure will be indeterminate.

FIG. 4B shows a receive procedure with communication between the service platform 481. As shown in step 401, the Audio Message from the Sender UE 451 is sent to the voice platform communication service 481 via the processes shown in FIG. 4A. The voice platform 481 may be equivalent to the voice platform 433 of FIG. 4A. In step 453, the voice platform 103 sends the call request to the Recipient UE 483 via the destination number +919129349569 for the Recipient UE 483. Then, the Recipient UE 483 detects that the caller identified with the number +919100000000 is the voice platform 481. Then, in step 455, a message received command is sent from the voice platform 481 to the Recipient UE 483 with the Sender UE's number +919177665544. In response, the Recipient UE 483 receives the Sender UE's number +919177665544, and sends a handshaking reply to the voice platform 481, as shown in step 457. Upon success of this command, in step 459, the command SUCCESS is sent from the voice platform 481 to the Recipient UE 483. Then, the audio message is transferred from the voice platform 481 to the Recipient UE 483, as shown in step 461. The command signifying that the transfer of the audio message is completed (i.e. end of discussion of message) is then sent from the voice platform 481 to the Recipient UE 483, as shown in step 463. Then, the Recipient UE 483 sends the command SUCCESS to the voice platform 481, as shown in step 465, and in response, the communication service 481 sends the command SUCCESS to the Recipient UE 483, as shown in step 467. Again, the Recipient UE 483 sends the command SUCCESS to the voice platform 481, as shown in step 465, and in response, the voice platform 481 sends the command SUCCESS to the Recipient UE 483, as shown in step 467. Therefore, via steps 465-471, two acknowledgements are made that the Recipient UE 483 successfully received the audio message, and two acknowledgements are made that the voice platform 481 successfully sent the audio message.

On the event of any failure or error, either the voice platform 481 or the Recipient UE 483 can terminate at any point of time, as an abort procedure. However, this abort procedure needs to happen before the two acknowledgments via steps 465-471. Otherwise, result of procedure will be indeterminate.

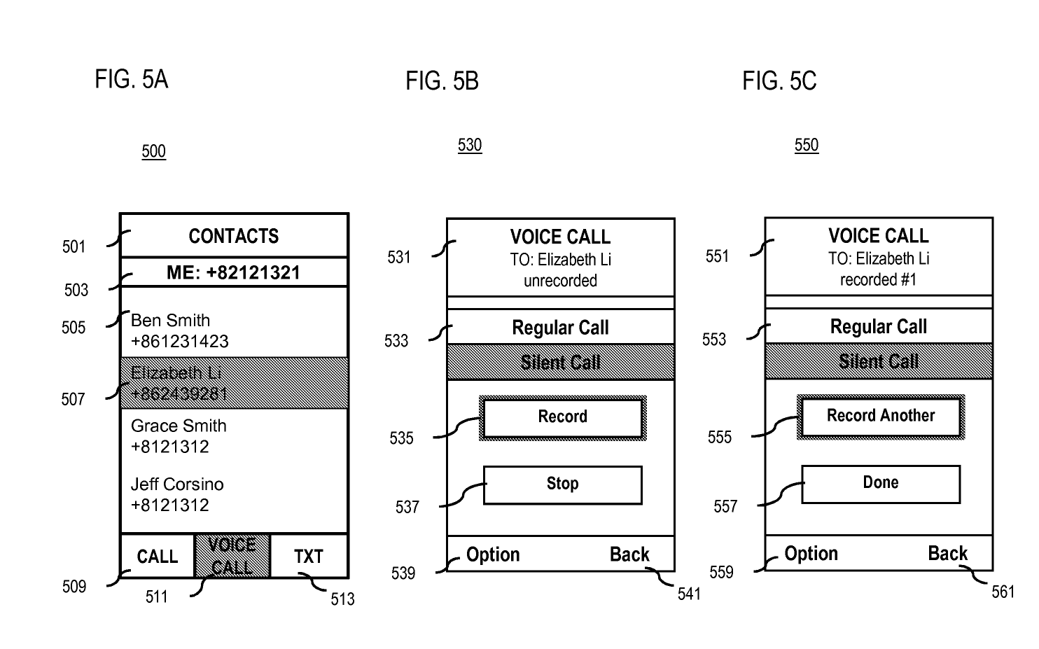

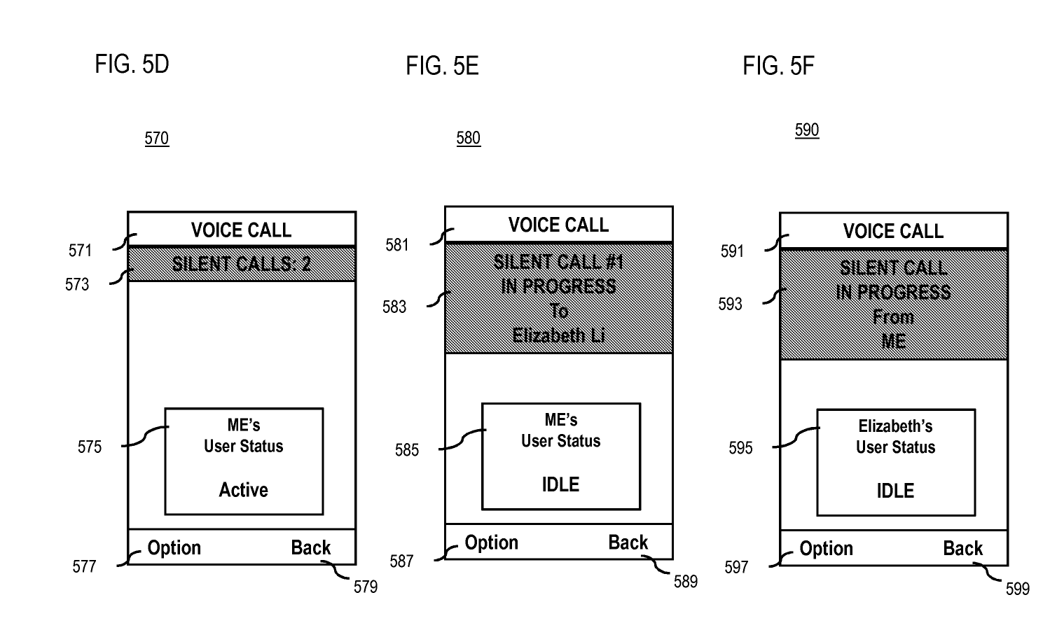

FIGS. 5A-5F are diagrams of user interfaces utilized in the processes of FIG. 3, according to various embodiments. FIG. 5A shows a contact list window 500 showing a contact list of other users that the user of the UE 101 may contact. The title section 501 shows that this interface shows a contact list. The user identification section 503 shows the name of the user (ME) of the UE 101 and the phone number of the user. The contact list 505 lists names of other users and their phone numbers. The selected user 507 is in a highlighted box. The interface also includes a regular call option 509 to place a regular phone call to the selected user, a voice call option 511 to send an audio message to the selected user, and a text option 513 to send a text to the selected user. In this example, the voice call option 511 is highlighted as a selected option. When the voice call option 511 is selected, the voice call window 530 as shown in FIG. 5B is displayed. The title section 531 shows that this interface is for the voice call option to the selected user (Elizabeth Li, in this example). The title section 531 also shows that no audio message is recorded (e.g. “unrecorded”). The call option 533 shows a regular call and a silent call. If the regular call is selected, the recorded audio message may be transmitted to the communication service 103 at any time. On the contrary, if the silent call is selected, the recorded audio message may be transmitted when the device is in the idle state. In this example, the silent call option is selected, as highlighted. The record option 535 may be selected to start recording the audio message, and the stop 537 option may be selected to stop recording. The Option 539 may be selected to display any other options that a user may choose at the UE 101. The Back button 541 may be selected to go back to a previous user interface or a previous screen.

After an audio message is recorded, the voice call window 550 as shown in FIG. 5C is displayed. The title section 551 shows that this interface is for the voice call option to Elizabeth Li, and one audio message has been recorded (e.g. “recorded #1”). The call option 553 shows a regular call and a silent call, which has similar functionalities as the call option 533. The record another option 555 may be selected to record another audio message. The done option 557 may be selected to finish recording an audio message and transmit the recorded audio message according to the selected call option. The Option 559 and the Back button 561 have similar functionalities as the Option 539 and the Back button 541.

After the recording of the audio message is finished (e.g. after selecting the done option 557), the voice call window 570 shown in FIG. 5D is displayed. The title section 571 shows that this interface is for the voice call, and the communication section 573 shows that there are two recorded audio messages for a silent call. The user status section 575 shows whether the UE 101 is in an active state or an idle state. The user status section 575 in this example shows that the UE 101 is in an active state, and thus the silent call is not made during this active state. The Option 577 and the Back button 579 have similar functionalities as the Option 539 and the Back button 541.

FIG. 5E shows the voice call window 570 when the status is in the idle state. The title section shows 581 that this interface is for the voice call. The communication section 583 shows that audio message #1 is in a progress of being sent to Elizabeth Li as a silent call. The user status section 585 shows that the status is in the idle state. Because the status is in the idle state and the silent call option is selected, the audio message may be sent to the recipient, as shown in the communication section 583. The Option 587 and the Back button 589 have similar functionalities as the Option 577 and the Back button 579.

FIG. 5F shows the voice call window 590 at the device of the recipient (e.g. Elizabeth Li) receiving the audio message sent from the user (e.g. ME). The title section 591 shows that the interface is for the voice call. The communication section 593 shows that the audio message sent from the device of the user (e.g. ME) is being received at the device of the recipient, as a silent call. The user status section 595 shows that the recipient (Elizabeth Li) has its user status in the idle state. The voice platform 103 does not transmit the audio message from the user (e.g. ME) to the recipient (Elizabeth) if the user status is in the active state. In this example, because Elizabeth's status is in the idle state, the audio message is transmitted from the voice platform 103, and is received as a silent call. The Option 597 and the Back button 599 have similar functionalities as the Option 587 and the Back button 589.

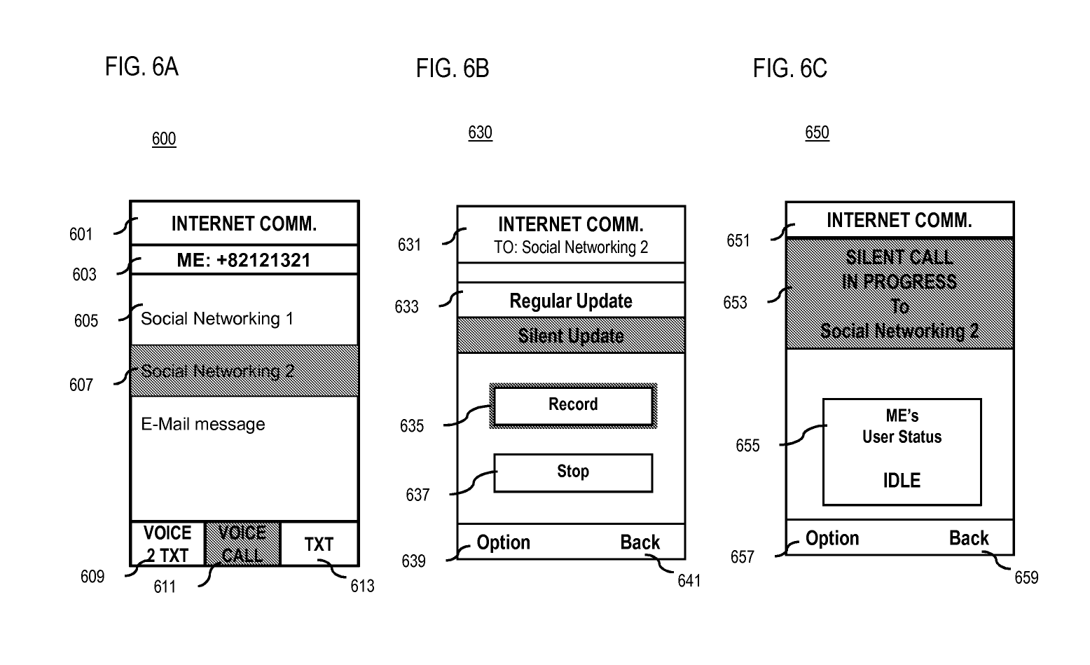

FIGS. 6A-6C are diagrams of user interfaces utilized in the processes of FIG. 3, according to various embodiments. FIG. 6A shows an internet communication window 600 to communicate with an internet service. The title window 601 shows that this interface is for the internet communication, and the identification section 503 shows the name of the user (ME) of the UE 101 and the phone number of the user. The internet service list 605 shows a list of internet services that can be selected to communicate. In this example, social networking 2 is selected, as in a highlighted box 607. The interface also includes a voice 2 text option 609 to place a regular phone call to the selected service which converts the voice to a text and update the service account with the text. The voice call option 611 may be selected send an audio message to the selected service account as an update, and a text option 613 may be selected to send a text to the selected service account to update the user status in the service. In this example, the voice call option 611 is highlighted as a selected option.

When the voice call option 611 is selected, the internet communication window 630 as shown in FIG. 6B is displayed. The title section 631 shows that this interface is for the voice call option to the selected service (Social Networking 2, in this example). The call option 633 shows a regular call and a silent call. If the regular call is selected, the recorded audio message may be transmitted to the communication service 103 at any time. On the contrary, if the silent call is selected, the recorded audio message may be transmitted when the device is in the idle state. In this example, the silent call option is selected, as highlighted. The record option 635 may be selected to start recording the audio message, and the stop 637 option may be selected to stop recording. The Option 639 may be selected to display any other options that a user may choose at the UE 101. The Back button 641 may be selected to go back to a previous user interface or a previous screen.

FIG. 6C shows the internet communication window 650 when the status is in the idle state. The title section shows 681 that this interface is for the internet communication. The communication section 683 shows that an audio message is in a progress of being sent to Social Networking 2 as a silent call. The user status section 685 shows that the status is in the idle state. Because the status is in the idle state and the silent call option is selected, the audio message may be sent to the Social Networking 2, as shown in the communication section 653. On the contrary, if the user status is in the active state, the silent call may not be made, and thus the audio message will not be sent to Social Networking 2. The Option 657 and the Back button 659 have similar functionalities as the Option 639 and the Back button 641.

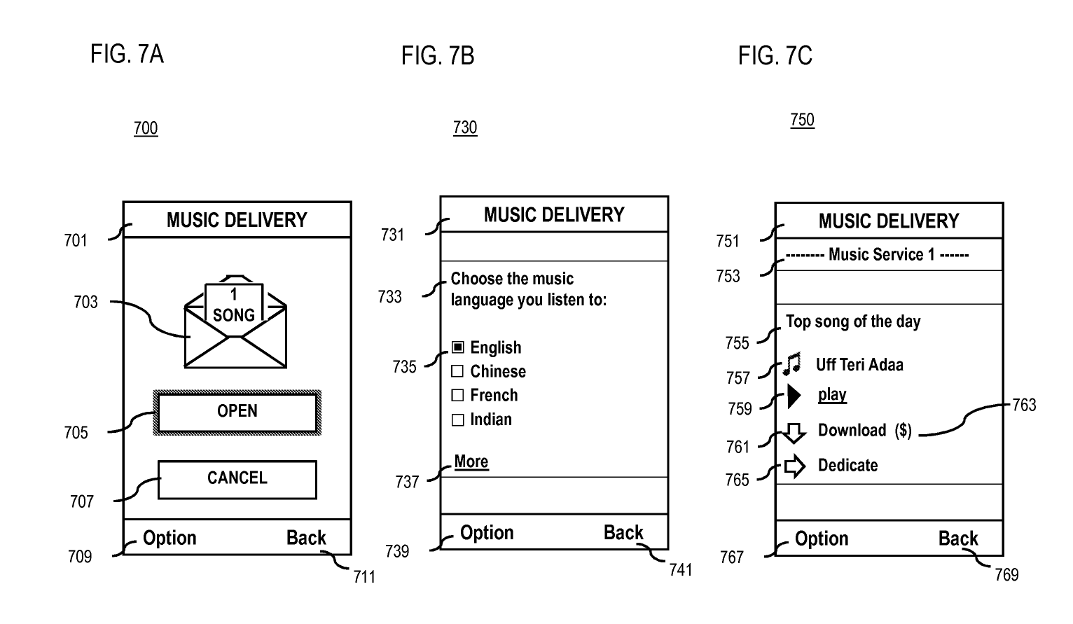

FIGS. 7A-7C are diagrams of user interfaces utilized in the processes of FIG. 3, according to various embodiments. FIG. 7A shows a music delivery window 700 when the song sent from a music service of the service platform 111 via the voice platform 103 and is received at the UE 101. The title section 701 shows that this interface is for the music delivery. The incoming message icon 703 shows that one song has arrived with an audio message. The open button 705 plays the audio message that includes a sample of the song. The cancel button 707 cancels the music delivery window. The Option 709 may be selected to display any other options that a user may choose at the UE 101. The Back button 701 may be selected to go back to a previous user interface or a previous screen.

FIG. 7B shows a music delivery window 730 where user preferences may be set, which may take place before or after the receipt of the audio message including the sample of the song. The title section 731 shows that this interface is for the music delivery. The language preference command 733 requests the user to select a preferred language for the music. In this example, English language option 735 is selected. Therefore, the communication service 103 selects songs in English to be transmitted to the UE 101. The more 737 option may be selected to display more preference parameters for the music. The preference parameters may include the genre, artists, the time when the song was published, age group of the user, etc. Then, the service platform 111 and/or the voice platform 103 may consider these parameters in selecting a song to be transmitted to the UE 101. The Option 739 and the Back button 741 have similar functionalities as the Option 709 and the Back button 711.

After the song is opened by selecting the open button 705, the window 750 describing the song and other options related to the song may be displayed, as shown in FIG. 7C. The title section 751 shows that this interface is for music delivery. The origin section 753 shows that the origin of the sample of the song is Music Service 1. Thus, the voice platform 103 may acquire the song from the Music Service 1, and generate the audio message including the sample of the song to transmit to the UE 101. The category of the song 755 shows that the song received at the UE 101 is the top song of the day. The title of the song 757 is Uff Teri Adaa. The play option 759 may be selected to play the sample of the song. In this example, the play option 759 is selected, as illustrated with the underline at the play option 759. The download option 761 may be selected to download the full version of the song. The song may be downloaded from the voice platform 103 or the Music Service 1. If the song is to be downloaded from the voice platform 103, when the download of the song is requested to the voice platform 103, the voice platform 103 may acquire the requested song from the Music Service 1, and then transmit the song to the UE 101. The money sign 763 indicates that the download option 761 requires a payment by the user. The dedicate option 765 forwards the sample of the song to another user selected by the user of the UE 101. The Option 767 and the Back button 769 have similar functionalities as the Option 739 and the Back button 741.

The processes described herein for providing communication services over audio messages may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

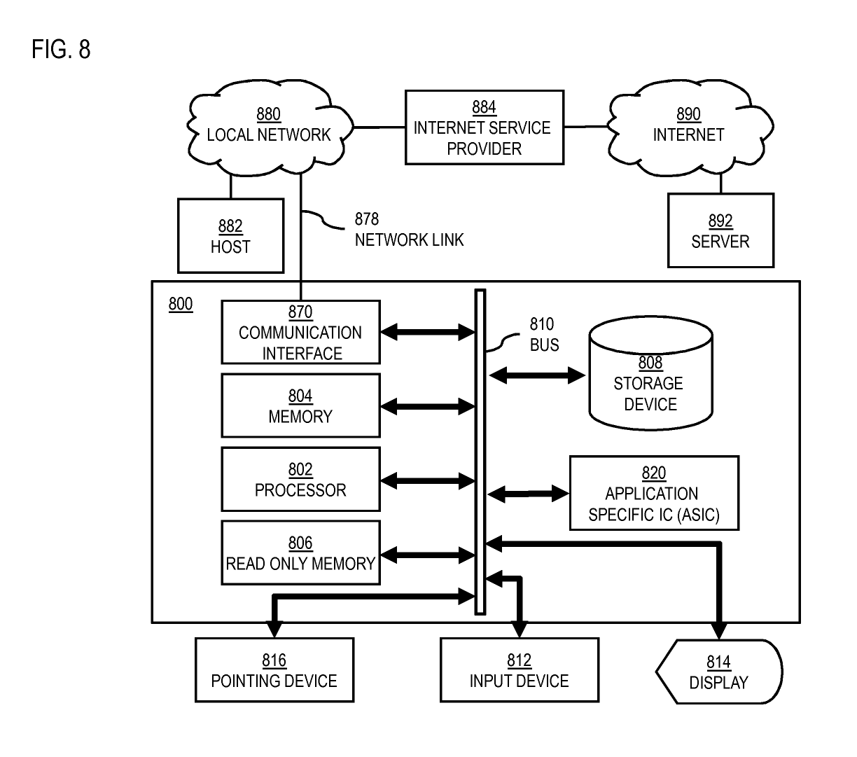

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to transmit an audio message to a recipient as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of transmitting an audio message to a recipient.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to transmitting an audio message to a recipient. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for transmitting an audio message to a recipient. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for transmitting an audio message to a recipient, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for transmitting an audio message to a recipient.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to transmit an audio message to a recipient as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of services. Chip set or chip 900, or a portion thereof, constitutes a means for performing one or more steps of transmitting an audio message to a recipient.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to transmit an audio message to a recipient. The memory 905 also stores the data associated with or generated by the execution of the inventive steps.

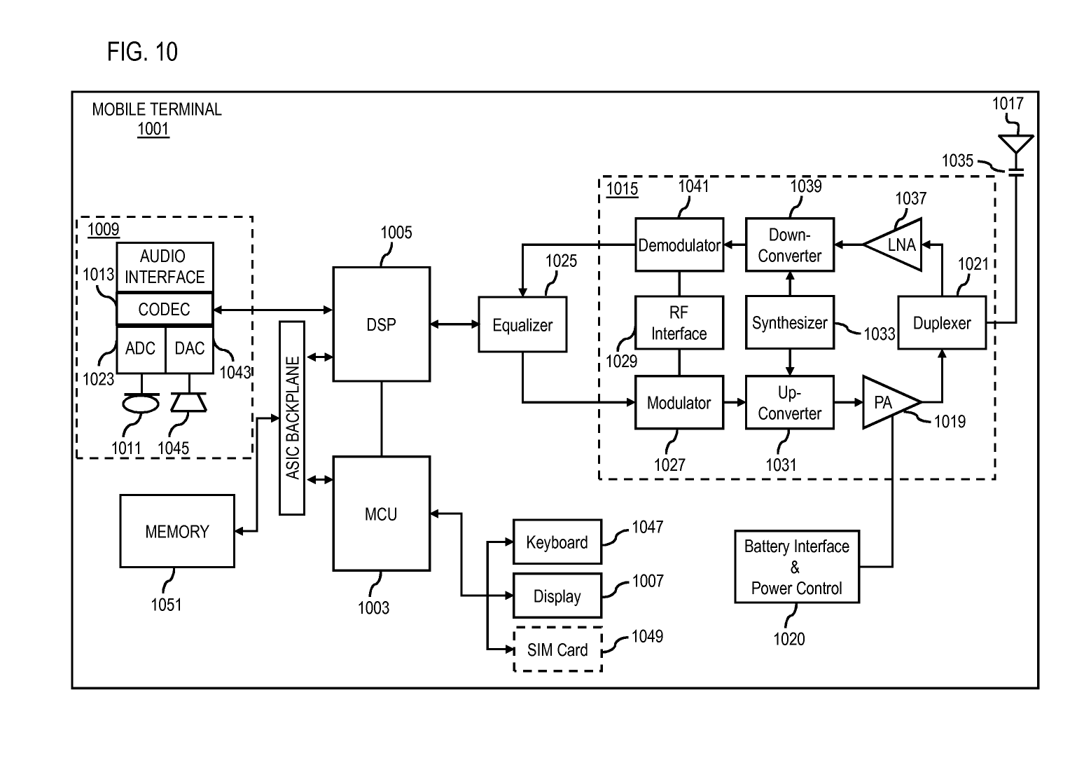

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of transmitting an audio message to a recipient. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of transmitting an audio message to a recipient. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to transmit an audio message to a recipient. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1.-20. (canceled)

21. A method comprising facilitating a processing of and/or processing (1) data and/or (2) information and/or (3) at least one signal, the (1) data and/or (2) information and/or (3) at least one signal based, at least in part, on the following:
at least one determination to act on a request to establish one or more calls among one or more devices and one or more services, the one or more calls including, at least in part, an audio message associated with the one or more services; and
an initiation of one or more actions that result in establishment of the one or more calls for transmission and storage of the audio message at the one or more devices, the one or more services, or a combination thereof.

22. A method of claim 21, wherein the (1) data and/or (2) information and/or (3) at least one signal are further based, at least in part, on the following:
at least one determination of an idle state of at least one of the one or more devices, wherein the establishment of the one or more calls is based, at least in part, on the idle state.

23. A method of claim 21, wherein the (1) data and/or (2) information and/or (3) at least one signal are further based, at least in part, on the following:
one or more criteria for selecting the one or more devices, the one or more services, or a combination thereof,
wherein the establishment of the one or more calls is based, at least in part, on the one or more criteria.

24. A method of claim 21, wherein at least one of the one or more services is a communication broadcast service, and wherein the (1) data and/or (2) information and/or (3) at least one signal are further based, at least in part, on the following:
a generation of the audio message to include an alert associated with the one or more services.

25. A method of claim 24, wherein the (1) data and/or (2) information and/or (3) at least one signal are further based, at least in part, on the following:
at least one determination of a characteristic of a user of the one or more devices,
wherein the generating of the audio message is based, at least in part, on the characteristic.

26. A method of claim 24, wherein the alert relates to an emergency, a government message, news, weather conditions, environmental conditions, a public service, traffic conditions, or a combination thereof.

27. A method of claim 21, wherein the (1) data and/or (2) information and/or (3) at least one signal are further based, at least in part, on the following:
at least one determination of user preferences for digital media; and
generating the audio message to include a sample of the digital media of the user preferences.

28. A method of claim 21, wherein the (1) data and/or (2) information and/or (3) at least one signal are further based, at least in part, on the following:
a download request for the digital media from the one or more devices; and
a transmission of the digital media to the one or more devices from which the down request is received.

29. A method of claim 21, wherein the (1) data and/or (2) information and/or (3) at least one signal are further based, at least in part, on the following:
at least one determination of the audio message associated with a social service from the one or more devices; and
a transmission of the received audio message to the associated social service.

30. An apparatus comprising:
at least one processor; and
at least one memory including computer program code for one or more programs, the at least one memory and the computer program code configured to, with the at least one processor, cause the apparatus to perform at least the following,
determine to act on a request to establish one or more calls among one or more devices and one or more services, the one or more calls including, at least in part, an audio message associated with the one or more services; and
cause, at least in part, actions that result in establishment of the one or more calls for transmission and storage of the audio message at the one or more devices, the one or more services, or a combination thereof.

31. An apparatus of claim 30, wherein the apparatus is further caused to:
determine an idle state of at least one of the one or more devices,
wherein the establishment of the one or more calls is based, at least in part, on the idle state.

32. An apparatus of claim 30, wherein the apparatus is further caused to:
determine one or more criteria for selecting the one or more devices, the one or more services, or a combination thereof,
wherein the establishment of the one or more calls is based, at least in part, on the one or more criteria.

33. An apparatus of claim 30, wherein at least one of the one or more services is a communication broadcast service, the apparatus is further caused to:
generate the audio message to include an alert associated with the one or more services.

34. An apparatus of claim 33, wherein the apparatus is further caused to:
determine a characteristic of a user of the one or more devices,
wherein the generating of the audio message is based, at least in part, on the characteristic.

35. An apparatus of claim 33, wherein the alert relates to an emergency, a government message, news, weather conditions, environmental conditions, a public service, traffic conditions, or a combination thereof.

36. An apparatus of claim 30, wherein the apparatus is further caused to:
determine user preferences for digital media; and generate the audio message to include a sample of the digital media of the user preferences.

37. An apparatus of claim 36, wherein the apparatus is further caused to:
receive a download request for the digital media from the one or more devices; and
cause, at least in part, transmission of the digital media to the one or more devices from which the down request is received.

38. An apparatus of claim 30, wherein the apparatus is further caused to:
receive the audio message associated with a social service from the one or more devices; and
cause, at least in part, transmission of the received audio message to the associated social service.

39. A computer program product including one or more sequences of one or more instructions which, when executed by one or more processors, cause an apparatus to at least perform the steps of:
determining to act on a request to establish one or more calls among one or more devices and one or more services, the one or more calls including, at least in part, an audio message associated with the one or more services; and
causing, at least in part, actions that result in establishment of the one or more calls for transmission and storage of the audio message at the one or more devices, the one or more services, or a combination thereof.

40. A computer program product of claim 39, further comprising:
determining an idle state of at least one of the one or more devices,
wherein the establishment of the one or more calls is based, at least in part, on the idle state.
